(19) United States
(12) Patent Application Publication
(10) Pub. No.: US 2013/0150483 A1
(43) Pub. Date: Jun. 13, 2013

(54) Thermally-Activated, High-Temperature Cement Suspending Agent

(71) Applicants: Gary Funkhouser, Duncan, OK (US); Matthew G. Kellum, Duncan, OK (US)

(72) Inventors: Gary Funkhouser, Duncan, OK (US); Matthew G. Kellum, Duncan, OK (US)

(73) Assignee: Halliburton Energy Services, Inc., Houston, TX (US)

(21) Appl. No.: 13/743,659

(22) Filed: Jan. 17, 2013

Related U.S. Application Data
(62) Division of application No. 13/101,413, filed on May 5, 2011.

(51) Int. Cl. C09K 8/46

(52) U.S. Cl. CPC C09K 8/46
USPC 523/130; 524/850

(57) ABSTRACT

A cementing fluid may include an aqueous fluid, a hydraulic cement, and a cement suspending agent comprising a crosslinked particulate, wherein the crosslinked particulate is made from a reaction comprising: a first monofunctional monomer, a primary crosslinker, and a secondary crosslinker. In some instances, the reaction may further comprise a second monofunctional monomer.

### BACKGROUND

The present invention relates to hydraulic cement suspending agents for use in high temperature wellbore applications, and methods relating thereto.

A natural resource such as oil or gas residing in a subterranean formation can be recovered by drilling a well into the formation. To do so, a wellbore is typically drilled down to the subterranean formation while circulating a drilling fluid through the wellbore. After the drilling is terminated, a string of pipe, e.g., casing, is run in the wellbore. Primary cementing is then usually performed whereby a cementing fluid, usually including water, cement, and particulate additives, is pumped down through the string of pipe and into the annulus between the string of pipe and the walls of the wellbore to allow the cementing fluid to set into an impermeable cement column and thereby seal the annulus. Subsequent secondary cementing operations, i.e., any cementing operation after the primary cementing operation, may also be performed. One example of a secondary cementing operation is squeeze cementing whereby a cementing fluid is forced under pressure to areas of lost integrity in the annulus to seal off those areas.

As the bottom hole circulating temperature of a well increases, the viscosity of a cementing fluid decreases. This decrease in viscosity, which is known as thermal thinning, can result in settling of the solids in the slurry. Undesirable consequences of the solids settling include free water and a density gradient in the set cement. To inhibit settling, cement suspending agents, e.g., crosslinked polymers, can be added to the cementing fluid. As the cementing fluid temperature increases, the cement suspending agent is thought to increase the viscosity of the cementing fluid, for example, by breaking crosslinks to release a polymer into the fluid. One important feature of a cement suspending agent is that it not adversely affect low-temperature rheology.

Existing cement suspending agents, e.g., guar or guar derivatives crosslinked with borate, delay crosslink breakage sufficiently to allow mixing and pumping of a cement fluid without imparting an excessively-high viscosity. However, those existing suspending agents are known to degrade above 300° F. This temperature limitation makes these cement suspending agents impractical for use in higher temperature applications.

### SUMMARY OF THE INVENTION

The present invention relates to hydraulic cement suspending agents for use in high temperature wellbore applications, and methods relating thereto.

In one embodiment, the present invention provides a method comprising: providing a cementing fluid comprising an aqueous liquid, a hydraulic cement, and a cement suspending agent that comprises a crosslinked particulate formed by a reaction comprising a first monofunctional monomer, a primary crosslinker, and a secondary crosslinker; placing the cementing fluid in a wellbore penetrating a subterranean formation; and allowing the cementing fluid to set therein.

In one embodiment, the present invention provides a cementing fluid comprising: an aqueous fluid, a cementitious particulate, and a cement suspending agent comprising a crosslinked particulate, wherein the crosslinked particulate is made from a reaction comprising: a first monofunctional monomer, a primary crosslinker, and a secondary crosslinker.

In one embodiment, the present invention provides a method comprising: providing a treatment fluid comprising an aqueous liquid, a plurality of particulates, and a suspending agent that comprises a crosslinked particulate formed by a reaction comprising a first monofunctional monomer and a primary crosslinker; placing the treatment fluid in a wellbore penetrating a subterranean formation with a bottom hole static temperature greater than about 225° F.; and allowing a plurality of crosslinks within the crosslinked particulate to degrade thereby allowing at least some of the polymer to dissolve and suspend the particulates.

In one embodiment, the present invention provides a method comprising: providing an oil solution comprising an oil-based solvent and a surfactant; providing a monomer mixture comprising an aqueous liquid, a first monofunctional monomer, and a primary crosslinker; forming an inverse suspension with the monomer mixture and the oil solution; reacting the monomer mixture in the inverse suspension with a free-radical initiator to react to form a crosslinked particulate; and isolating the crosslinked particulate.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1 is a plot of the experimental conditions and results described in the Examples section.

FIG. 2 is a plot of the experimental conditions and results described in the Examples section.

FIG. 3 is a plot of the experimental conditions and results described in the Examples section.

FIG. 4 is a plot of the experimental conditions and results described in the Examples section.

FIG. 5 is a plot of the experimental conditions and results described in the Examples section.

FIG. 6 is a plot of the experimental conditions and results described in the Examples section.

### DETAILED DESCRIPTION

The present invention relates to hydraulic cement suspending agents for use in high temperature wellbore applications, and methods relating thereto.

Of the many advantages of the present invention, the present invention provides compositions that protect against thermal thinning of cements at elevated temperature, and methods thereof. The present invention provides cement suspending agents that are useful in subterranean formations that have bottom hole static temperatures (BHST) of 225° F. or greater, including those formations that have a bottom hole static temperature in excess of about 400° F. Thus, the applicability of the cement suspending agents of the present invention encompasses a significantly higher temperature range than other, known cement suspending agents. The cement suspending agents of the present invention are designed to not adversely affect the low-temperature viscosity of a treatment fluid. Additionally, the cement suspending agents of the present invention may be applicable to a wide variety of subterranean formations and/or wellbore treatments where a particulate suspending aid is needed in high temperature applications, including in cementing fluids, spacer fluids, flush fluids, and fracturing fluids. When used in cementing fluids, the cement suspending agents may not adversely affect the setting time of a cementitious composition or the final strength of a cementitious composition.

Some embodiments of the present invention provide cementing fluids suitable for use in a subterranean wellbore comprising an aqueous liquid, a hydraulic cement, and a cement suspending agent. The cement suspending agent generally comprises a crosslinked particulate formed by a reaction comprising a first monofunctional monomer, a primary crosslinker, and a secondary crosslinker. In some embodiments the cementing fluid may then be placed into a wellbore penetrating a subterranean formation and allowed to set therein.

Some embodiments of the present invention provide methods comprising providing an oil solution, which itself comprises an oil-based solvent and a surfactant, and providing a monomer mixture, which itself comprises an aqueous liquid, a first monofunctional monomer, and a primary crosslinker. An inverse suspension may then be formed from the monomer mixture and the oil solution. A crosslinked particulate may be formed by reacting the monomer mixture in the inverse suspension with a free-radical initiator. The crosslinked particulates may be further isolated and used in subterranean treatments.

Other embodiments of the present invention provide methods that provide a treatment fluid comprising an aqueous liquid, a plurality of particulates, and a suspending agent. In such methods, the suspending agent generally comprises a crosslinked particulate formed by a reaction comprising a first monofunctional monomer and a primary crosslinker. In some embodiments the treatment fluid comprising the crosslinked particulate may be placed in a wellbore penetrating a subterranean formation with a bottom hole static temperature greater than about 225° F. The plurality of crosslinks in the crosslinked particulate may be allowed to degrade, thereby allowing at least some of the polymer to dissolve and suspend the particulates.

In some embodiments, a cement suspending agent of the present invention may comprise a crosslinked particulate, wherein the crosslinked particulate has been formed by a reaction comprising a first monofunctional monomer, a primary crosslinker, and optionally a secondary crosslinker. It should be understood that the term “particulate” or “particle,” as used in this disclosure, includes all known shapes of materials, including, but not limited to, spherical materials, substantially spherical materials, low to high aspect ratio materials, fibrous materials, polygonal materials (such as cubic materials), and mixtures thereof. In some embodiments, a crosslinked particulate may be formed from a reaction that comprises a first monofunctional monomer, a second monofunctional monomer, and a primary crosslinker. In some embodiments, a crosslinked particulate may comprise a first monofunctional monomer, a second monofunctional monomer, a primary crosslinker, and a secondary crosslinker. In some embodiments, a first monofunctional monomer and a second monofunctional monomer may be different. In some embodiments, a primary crosslinker and a secondary crosslinker may be different.

It should be noted that when “about” is provided at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

Suitable monofunctional monomers for use in the present invention may be a monomer containing a vinyl or vinylidene group that is stable in a polymerized and/or crosslinked form at a high temperature, i.e., above 225° F. As used herein, “stable” refers to substantially nondegradable on the timescale of the performance requirement. Suitable monofunctional monomers include N-substituted and N,N-disubstituted acrylamides. Other suitable monofunctional monomers include N-vinylamides and N-alkyl-N-vinylamides. Examples of monofunctional monomers include, but are not limited to, N,N-dimethylacrylamide, sodium 2-acrylamido-2-methylpropanesulfonate, 2-acrylamido-2-methylpropanesulfonic acid, N-(hydroxymethyl)acrylamide, N-(hydroxyethyl)acrylamide, acrylamide, methacrylamide, N-vinylformamide, 1-vinyl-2-pyrrolidinone, N-vinylcaprolactam, N-acryloyl morpholine, N-methyl-N-vinylacetamide, N-isopropylacrylamide, N,N-diethylacrylamide, sodium 4-styrenesulfonate, vinylsulfonic acid, and any derivative thereof. It should be noted that a mixture of monofunctional monomers may also be applicable for use in the present invention.

In some embodiments, a crosslinked particulate may be formed from a reaction that comprises a first and a second monofunctional monomer. A ratio of first monofunctional monomer to second monofunctional monomer may be present in the reaction in an amount ranging from a lower limit of about 0.1:99.9, 1:99, 5:95, 10:90, 25:75 or 50:50 to an upper limit of about 99.9:0.1, 99:1, 90:10, 75:25, or 50:50, and wherein the amount may range from any lower limit to any upper limit and encompass any subset between the upper and lower limits.

Suitable primary crosslinkers for use in the present invention may be a crosslinker with at least two vinyl or vinylidene groups that form at least one crosslink that is hydrolytically stable at ambient temperature and hydrolytically unstable at high temperature, i.e., above 225° F., on the timescale of the well treatment. As used herein, “hydrolytically stable,” and any derivative thereof, indicates stable against hydrolysis. Examples of primary crosslinkers include, but are not limited to, ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, ethoxylated trimethylolpropane triacrylate, and any derivative thereof. A suitable primary crosslinker may hydrolyze at temperatures ranging from a lower limit of about 225° F., 275° F., 300° F., 325° F., 350° F., 400° F., or 450° F. to an upper limit of about 700° F., 650° F., 600° F., 550° F., 500° F., 450° F., or 400° F., and wherein the temperature may range from any lower limit to any upper limit and encompass any subset between the upper and lower limits. A primary crosslinker may be present in the reaction to form a crosslinked particulate in an amount ranging from a lower limit of about 0.1%, 0.5%, 1%, 5%, or 10% by weight of total monomer to an upper limit of about 20%, 15%, 10%, 5%, or 1% by weight of total monomer, and wherein the amount may range from any lower limit to any upper limit and encompass any subset between the upper and lower limits.

Suitable secondary crosslinkers for use in the present invention may be any known bisacrylamide crosslinker that forms at least one crosslink that is hydrolytically unstable at high temperature, i.e., above 225° F., on the timescale of the well treatment. Examples of secondary crosslinkers include, but are not limited to, N,N′-methylenebisacrylamide, N,N′-(1,2-dihydroxy-1,2-ethanediyl)bisacrylamide, N,N(1,2-ethanediyl)bisacrylamide, N,N′-[[2,2-bis(hydroxymethyl)-1,3 -propanediyl]bis(oxymethylene)]bisacrylamide, bis(2-methacryloyl)oxyethyl disulfide, N,N′-bis(acryloyl)cystamine, and any derivative thereof. A suitable secondary crosslinker may hydrolyze at temperatures ranging from a lower limit of about 225° F., 275° F., 300° F., 325° F., 350° F., 400° F., or 450° F. to an upper limit of about 700° F., 650° F., 600° F., 550° F., 500° F., 450° F., or 400° F., and wherein the temperature may range from any lower limit to any upper limit and encompass any subset between the upper and lower limits. A secondary crosslinker may be present in a crosslinked particulate in an amount ranging from a lower limit of about 0.005%, 0.01%, 0.05%, or 0.1% by weight of total monomer to an upper limit of about 0.5%, 0.25%, 0.1%, or 0.05% by weight of total monomer, and wherein the amount may range from any lower limit to any upper limit and encompass any subset between the upper and lower limits.

In preferred embodiments, the secondary crosslinker may be hydrolytically stable to a higher temperature than the primary crosslinker

In some embodiments, when the temperature exceeds the temperature at which the primary and/or secondary crosslinker hydrolyzes, the crosslinker may hydrolyze thereby allowing the polymer comprising the first and/or second monofunctional monomer to dissolve in a treatment fluid.

In some embodiments, a cement suspending agent of the present invention may be used in a treatment fluid comprising a particulate. In some embodiments, when the primary and/or secondary crosslinkers hydrolyze, the polymer comprising the first and/or second monofunctional monomer may dissolve in the treatment fluid thereby inhibiting settling of a particulate suspended in a treatment fluid. In some embodiments, the cement suspending agents may be used in a treatment fluid comprising a particulate, wherein the particulate needs to be maintained in suspension at temperatures greater than about 225° F., 275° F., 300° F., 325° F., 350° F., 400° F., or 450° F.

A suitable particulate for use in the present invention may be any particulate suitable for use in a subterranean formation including, but not limited to, cementitious particulates, weighting agents, proppants, fine aggregate particulates, and any combination thereof. Suitable particulates for use in the present invention may have a diameter ranging from a lower limit of about 0.5 μm, 1 μm, 10 μm, 50 μm, 0.1 mm, or 1 mm to an upper limit of about 10 mm, 1 mm, 0.5 mm, 0.1 mm, or 50 μm, and wherein the diameter may range from any lower limit to any upper limit and encompass any subset between the upper and lower limits. A particulate may be present in a treatment fluid in an amount ranging from a lower limit of about 10%, 20%, 30%, 40%, or 50% by weight of treatment fluid to an upper limit of about 90%, 80%, 70%, 60%, 50%, or 40% by weight of treatment fluid, and wherein the amount may range from any lower limit to any upper limit and encompass any subset between the upper and lower limits.

The terms “cement” and “hydraulic cement” may be used interchangeably in this application. As used herein, the terms refer to compounds of a cementitious nature that set and/or harden in the presence of water. Suitable hydraulic cements for use in the present invention may be any known hydraulic cement including, but are not limited to, a Portland cement including API classes A, B, C, G, and H; a slag cement; a pozzolana cement; a gypsum cement; an aluminous cement; a silica cement; a high alkalinity cement; and any combination thereof. In some embodiments, a cementing fluid may comprise an aqueous liquid, a hydraulic cement, and a cement suspending agent.

Suitable weighting agents for use in the present invention may be any known weighting agent that is a particulate including, but not limited to, barite; hematite; manganese tetraoxide; galena; silica; siderite; celestite; ilmenite; dolomite; calcium carbonate; and any combination thereof.

Suitable proppants for use in the present invention may be any known proppant including, but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and any combination thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and any combination thereof.

Suitable fine aggregate particulates for use in the present invention may include, but are not limited to, fly ash, silica flour, fine sand, diatomaceous earth, lightweight aggregates, hollow spheres, and any combination thereof.

Suitable aqueous fluids for use in the present invention may comprise fresh water, saltwater (e.g., water containing one or more salts dissolved therein), brine (e.g., saturated salt water), seawater, and any combination thereof. Generally, the water may be from any source, provided that it does not contain components that might adversely affect the stability and/or performance of the compositions or methods of the present invention.

While a number of preferred embodiments described herein relate to cementing fluids, it is understood that other treatment fluids may also be prepared according to the present invention including, but not limited to, spacer fluids, drilling fluids, fracturing fluids, and lost circulation fluids. As referred to herein, the term “spacer fluid” should be understood to mean a fluid placed within a wellbore to separate fluids, e.g., to separate a drilling fluid within the wellbore from a cementing fluid that will subsequently be placed within the wellbore.

In some embodiments, a cement suspending agent may be included in a first fluid that is placed in a wellbore and/or subterranean formation before and/or after a second fluid, wherein the second fluid comprises a plurality of particulates and the cement suspending agent. In some embodiments, the concentration of cement suspending agent may be different in a first fluid than in a second fluid. In some embodiments, the first fluid may be a spacer fluid and the second fluid may be a treatment fluid.

The teachings of the present invention and the methods and compositions of the present invention may be used in many different types of subterranean treatment operations. Such operations include, but are not limited to, casing operations, plugging operations, drilling operations, lost circulation operations, completion operations, and water-blocking operations. In some embodiments, the suspending aid of the present invention may be used as a secondary gelling agent in a high-temperature fracturing treatment. The methods and compositions of the present invention may be used in large-scale operations or pills. As used herein, a “pill” is a type of relatively small volume of specially prepared treatment fluid placed or circulated in the wellbore.

In some embodiments, a cement suspending agent may be used in a wellbore and/or subterranean formation with a bottom hole static temperature (BHST) ranging from a lower limit of about 225° F., 275° F., 300° F., 325° F., 350° F., 400° F., or 450° F. to an upper limit of about 700° F., 650° F., 600° F., 550° F., 500° F., 450° F., or 400° F., and wherein the temperature may range from any lower limit to any upper limit and encompass any subset between the upper and lower limits.

In some embodiments, a cement suspending agent may be provided in wet or dry form. In some embodiments, a suspending agent may be added to a treatment fluid on-site or off-site of the wellbore location.

In some embodiments, a cement suspending agent may be produced by providing an oil solution comprising an oil-based solvent and a surfactant; providing a monomer mixture comprising an aqueous liquid and the monomers and the crosslinkers needed for a desired crosslinked particulate; forming an inverse suspension with the monomer mixture and the oil solution; and reacting a free-radical initiator with the monomer mixture in the inverse suspension to form a crosslinked particulate. Without being limited by theory or mechanism, it is believed that as a crosslinked polymer forms in the inverse suspension it generates crosslinked particulates. In some embodiments, a crosslinked particulate may be isolated by a method including, but not limited to, drying either by water-miscible solvent extraction or azeotropic distillation; followed by filtration or centrifugation to remove the oil-based solvent. Alternatively, the crosslinked particulate may be isolated from the oil-based solvent before drying with air. One skilled in the art, with the benefit of this disclosure, will recognize suitable procedural variations, including order of addition, to achieve the desired crosslinked particulate. For example, when reacting the free radical initiator with the monomer mixture, the free radical initiator may be added to the monomer mixture shortly before forming the inverse emulsion, to the oil solution before forming the inverse suspension, to the inverse suspension, or any combination thereof.

Suitable oil-based solvents may include, but are not limited to, paraffinic hydrocarbons, aromatic hydrocarbons, olefinic hydrocarbons, petroleum distillates, synthetic hydrocarbons, and any combination thereof. Examples of a suitable oil-based solvent include ESCAID® (a low viscosity organic solvent, available from ExxonMobil, Houston, Tex.). Suitable surfactants may include, but are not limited to, a HYPERMER® (a nonionic, polymeric surfactant, available from Croda, Edison, N.J.), block copolymers of ethylene oxide and propylene oxide, block copolymers of butylene oxide and ethylene oxide, sorbitan esters, copolymers of methacrylic acid and C₁₂-C₁₈ alkyl methacrylates, alkylarylsulfonate salts, and any combination thereof. Suitable free radical initiators may be any water-soluble free radical initiator including, but not limited to, persulfate salts, organic peroxides, organic hydroperoxides, azo compounds (e.g. 2,2′-azobis(2-amidinopropane)dihydrochloride), and any combination thereof. One skilled in the art with the benefit of this disclosure will recognize the plurality of applicable oil-based solvents, surfactants, and free radical initiators and the appropriate concentrations of each needed for producing a crosslinked particulate.

To facilitate a better understanding of the present invention, the following examples of preferred embodiments are given. In no way should the following examples be read to limit, or to define, the scope of the invention.

### EXAMPLES

Cement suspending agent synthesis. A 250 mL round bottom, 3 necked flask was fitted with an overhead stirrer and a nitrogen purge. The flask was charged with 100 mL ESCAID®110 oil-based solvent and 1 mL of HYPERMER® 1031 polymeric surfactant. Monomer mixture was prepared by combining 20 g of monofunctional monomer, primary crosslinking monomer (as indicated), secondary crosslinking monomer (as indicated), water (as indicated), and 0.2 mL of triethanolamine in a 50 mL beaker. Then 0.2 mL of 10% w/v sodium persulfate was mixed into the monomer mixture. Immediately after adding the sodium persulfate, the monomer mixture was added to the three-necked flask and the stirring rate was set to 200 rpm to form the water-in-oil (inverse phase) suspension. The mixture was stirred until the reaction was complete, as indicated by a temperature rise followed by cooling to ambient temperature. The product, a crosslinked particulate, was subsequently isolated by either acetone extraction or azeotropic distillation, followed by filtration.

For acetone extraction, the product mixture was poured into approximately 300 mL of acetone to extract the water from the crosslinked particulate. The product was collected on a Buchner funnel by vacuum filtration. The product was subsequently rinsed with acetone to remove residual oil and air-dried.

For azeotropic distillation, approximately 50 mL of heptane was added to the three-necked flask. The overhead stirrer was replaced with a Dean-Stark trap and reflux condenser and the flask was fitted with a thermometer and temperature controller. The mixture was stirred (magnetically) and heated to reflux until the water was distilled from the product. The resulting dry, crosslinked particulate was separated from the hydrocarbon mixture by vacuum filtration on a Buchner funnel. The product was rinsed with acetone to remove residual oil and air-dried.

Cement suspending agents tested. The following five cement suspending agent (“CSA”) compositions were prepared by the above procedures.

TABLE 1
(CSA-1)

```
Monomer mixture:
  1.984 g EO(15) trimethylolpropane triacrylate (Sartomer SR9035)
  15.341 g N,N-dimethylacrylamide (Aldrich)
  10.179 g 50% w/w sodium 2-acrylamido-2-methylpropanesulfonic acid
  (AMPS) (Lubrizol AMPS 2405)
No additional water added.
Worked up with acetone extraction.
```

TABLE 2
(CSA-2)

```
Monomer mixture:
  1.984 g EO(15) trimethylolpropane triacrylate (Sartomer SR9035)
  15.008 g N,N-dimethylacrylamide (Aldrich)
  10.005 g 50% w/w sodium AMPS (Lubrizol AMPS 2405)
  0.30 mL 0.5% w/v N,N′-methylenebisacrylamide (Aldrich)
No additional water added.
Worked up with acetone extraction.
```

TABLE 3
(CSA-3)

```
Monomer mixture:
  1.999 g polyethylene glycol diacrylate, Mₙ = 258 (Aldrich)
  15.000 g N,N-dimethylacrylamide (Aldrich)
  10.006 g 50% w/w sodium AMPS (Lubrizol AMPS 2405)
  0.50 mL 0.5% w/v N,N′-methylenebisacrylamide (Aldrich)
No additional water added.
Worked up with acetone extraction.
```

TABLE 4
(CSA-4)

```
Monomer mixture:
  2.000 g polyethylene glycol diacrylate, Mₙ = 258 (Aldrich)
  15.000 g N,N-dimethylacrylamide (Aldrich)
  9.998 g 50% w/w sodium AMPS (Lubrizol AMPS 2405)
  0.50 mL 0.5% w/v N,N′-methylenebisacrylamide (Aldrich)
15.099 g additional deionized water added.
Worked up with acetone extraction.
```

TABLE 5
(CSA-5)

```
Monomer mixture:
  2.004 g polyethylene glycol diacrylate, Mₙ = 258 (Aldrich)
  15.0740 g N,N-dimethylacrylamide (Aldrich)
  10.003 g 50% w/w sodium AMPS (Lubrizol AMPS 2405)
  0.50 mL 0.5% w/v N,N′-methylenebisacrylamide (Aldrich)
15.006 g additional deionized water added.
Worked up with azeotropic distillation.
```

Settling Test. Cement slurries containing the above cement suspending agents were prepared according to API RP10B, Recommended Practice for Testing Well Cements: 500 g Texas Lehigh Class H cement; 372.3 g weighting agent HI-DENSE® #4 (non-radioactive and non-magnetic hematite, available from Halliburton Energy Services, Inc.); 175 g weighting agent SSA®-2 (sand, available from Halliburton Energy Services, Inc.); 5 g fluid-loss control agent HALAD®-413 (synthetic polymer, available from Halliburton Energy Services, Inc.); 5 g retarder HR®-12 (calcium lignosulfonate and organic acid, available from Halliburton Energy Services, Inc.); 1.25 g retarder HR®-25 (cement retarder, available from Halliburton Energy Services, Inc.); 3.75 g cement suspending agent; and 285.6 g tap water.

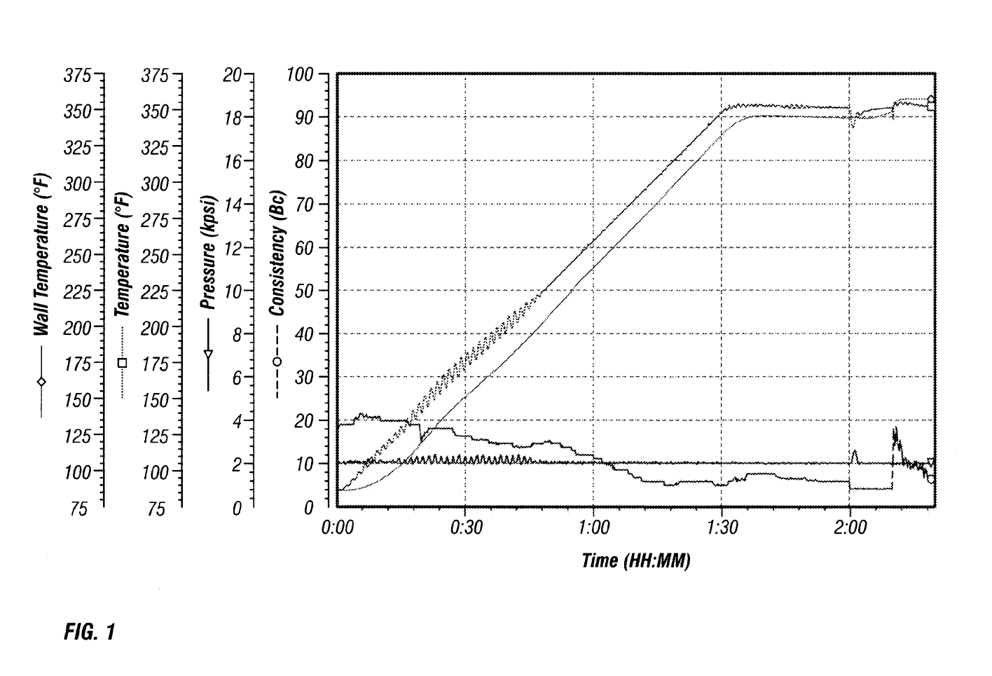

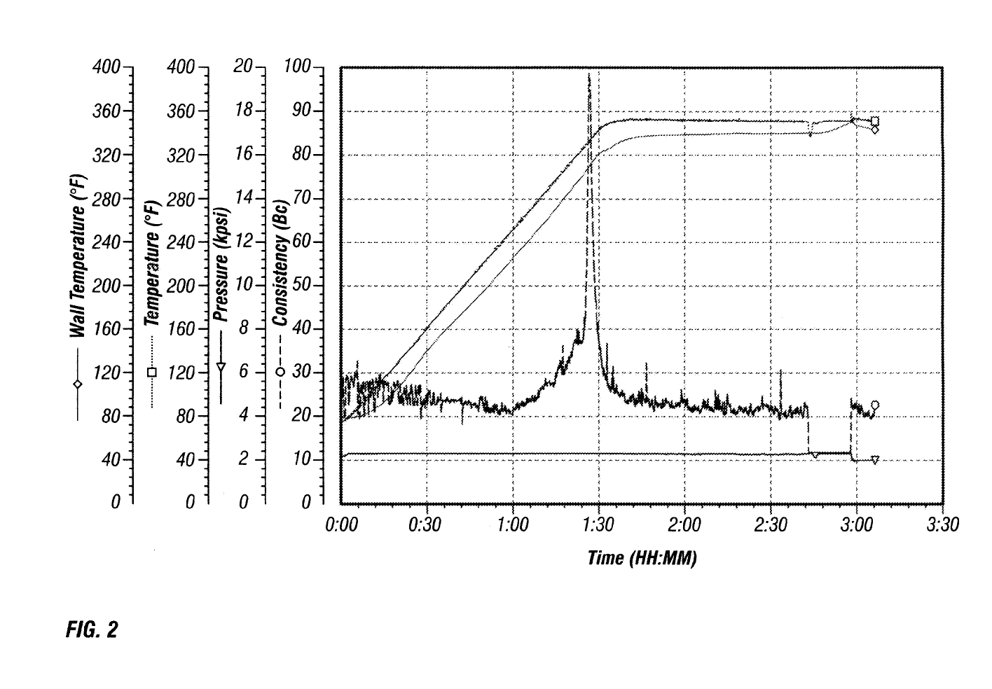

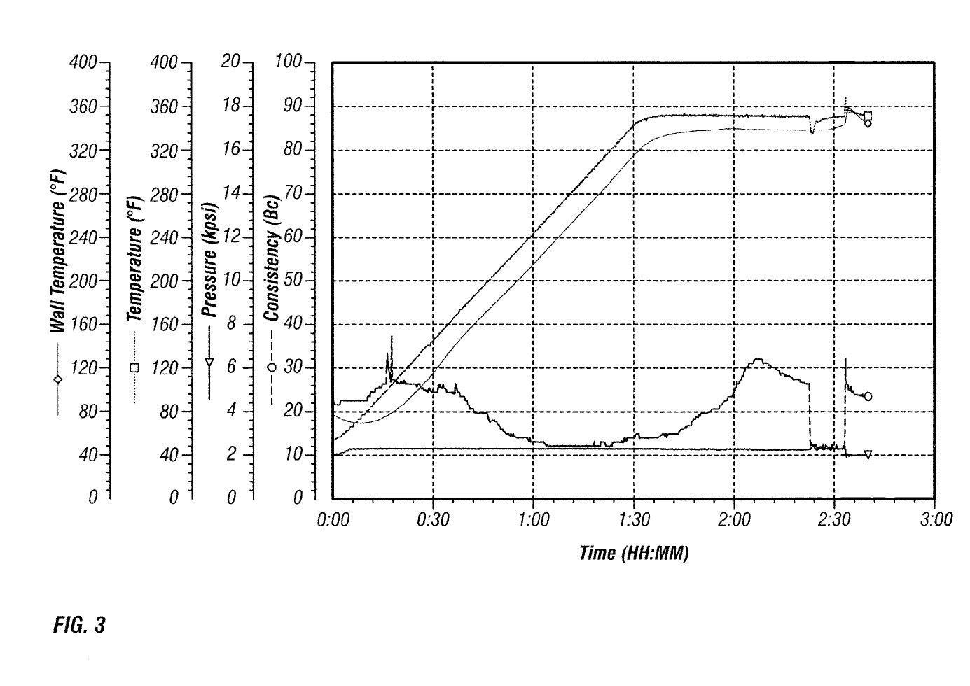

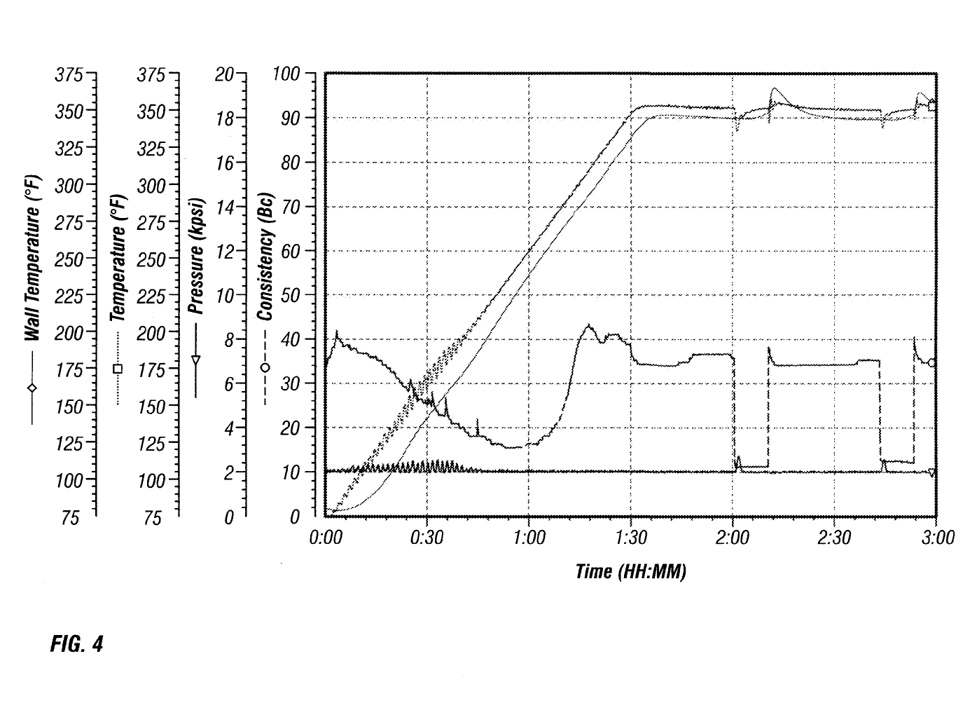

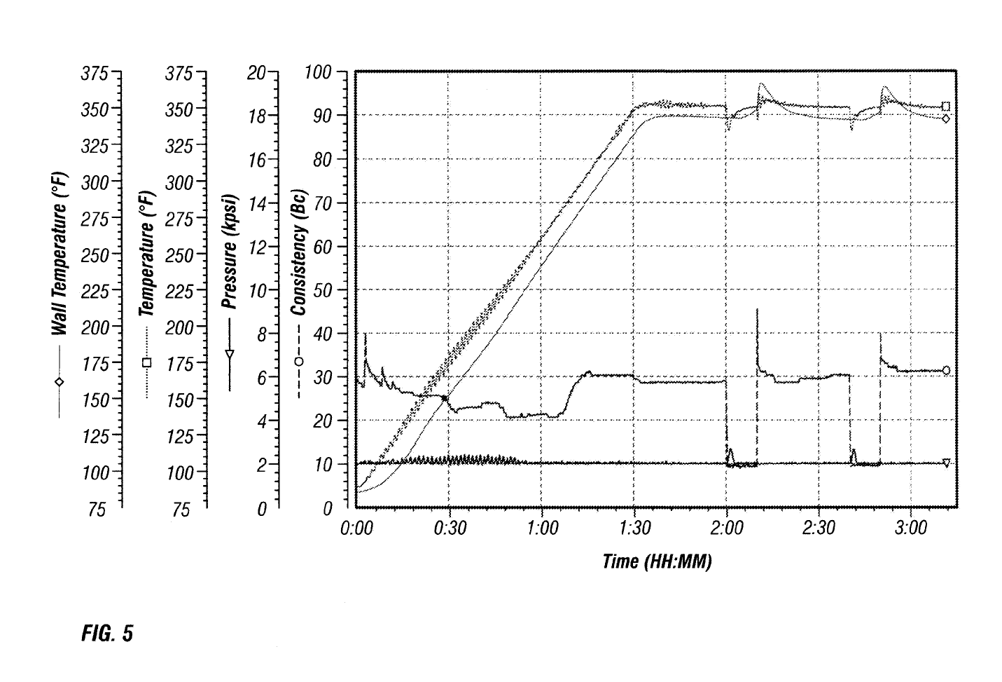

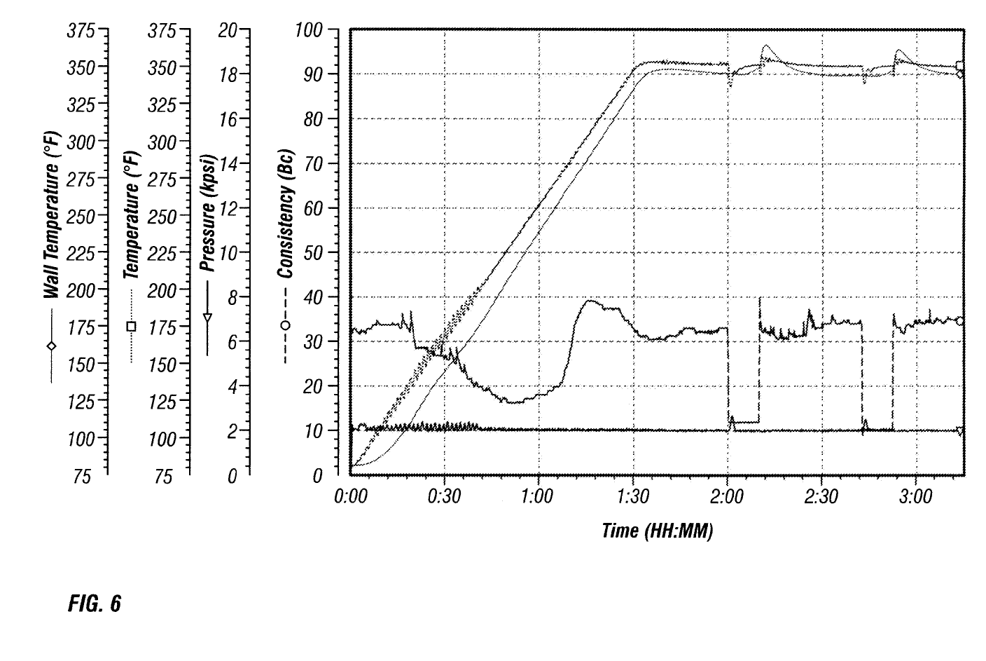

The slurry was transferred to a Halliburton high-pressure, high-temperature consistometer with Chandler modifications for data acquisition. The consistometer was programmed to heat to a chamber temperature of 350° F. over 90 minutes at a constant pressure of 2000 psi. Upon reaching 350° F., the temperature and pressure were held constant for the remainder of the test. After a minimum of 2 hours elapsed time, the stirrer motor was shut off for 10 minutes, and then restarted. This off/on cycle may be repeated one or more times, depending on the test. A test is considered successful if the slurry resumes stirring when restarted. A failed test is indicated by a broken shear pin in the slurry can drive disk caused by excessive torque from settled cement. FIG. 1 provides the experimental conditions and results of the consistometer screening test for a control cement sample. FIGS. 2-6 provide the experimental conditions and results of the consistometer screening test for a cement sample containing cement suspending agents of the present invention.

| Sample | Setting Test Results |
|---|---|
| Control | Failed (pin sheared, severe settling) |
| (no cement suspending agent) | |
| CSA-1 (FIG. 2) | Passed (pin did not shear, slight settling) |
| CSA-2 (FIG. 3) | Passed (pin did not shear, no settling) |
| CSA-3 (FIG. 4) | Passed (pin did not shear, no settling) |
| CSA-4 (FIG. 5) | Passed (pin did not shear, no settling) |
| CSA-5 (FIG. 6) | Passed (pin did not shear, no settling) |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1-20. (canceled)

21. A cementing fluid comprising:
an aqueous fluid,
a hydraulic cement, and
a cement suspending agent comprising a crosslinked particulate, wherein the crosslinked particulate is made from a reaction comprising:
a first monofunctional monomer,
a primary crosslinker, and
a secondary crosslinker.

22. The cementing fluid of claim 21 further comprising at least one selected from the group consisting of a weighting agent, a fine aggregate particulate, and any combination thereof.

23. The cementing fluid of claim 21, wherein the first monofunctional monomer comprises a monomer selected from the group consisting of N,N-dimethylacrylamide, sodium 2-acrylamido-2-methylpropanesulfonate, 2-acrylamido-2-methylpropanesulfonic acid, N-(hydroxymethyl)acrylamide, N-(hydroxyethyl)acrylamide, acrylamide, methacrylamide, N-vinylformamide, 1-vinyl-2-pyrrolidinone, N-vinylcaprolactam, N-acryloyl morpholine, N-methyl-N-vinylacetamide, N-isopropylacrylamide, N,N-diethylacrylamide, sodium 4-styrenesulfonate, and vinylsulfonic acid.

24. The cementing fluid of claim 21, wherein the primary crosslinker is present in the reaction at about 0.1% to about 20% by weight of total monomer.

25. The cementing fluid of claim 21, wherein the primary crosslinker comprises a crosslinking agent selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, and ethoxylated trimethylolpropane triacrylate, and any combination thereof.

26. The cementing fluid of claim 21, wherein the secondary crosslinker is present in the reaction at about 0.005% to about 0.5% by weight of total monomer.

27. The cementing fluid of claim 21, wherein the secondary crosslinker comprises a crosslinking agent selected from the group consisting of N,N′-methylenebisacrylamide, N,N′-(1,2-dihydroxy-1,2-ethanediyl)bisacrylamide, N,N′-(1,2-ethanediyl)bisacrylamide, and N,N′-[[2,2-bis(hydroxymethyl)-1,3-propanediyl]bis(oxymethylene)]bisacrylamide, bis(2-methacryloyl)oxyethyl disulfide, and N,N′-bis(acryloyl)cystamine, and any combination thereof.

28. A cementing fluid comprising:
an aqueous fluid,
a hydraulic cement, and
a cement suspending agent comprising a crosslinked particulate, wherein the crosslinked particulate is made from a reaction comprising:
a first monofunctional monomer,
a second monofunctional monomer,
a primary crosslinker, and
a secondary crosslinker, wherein the first monofunctional monomer and the second monofunctional monomer are different.

29. The cementing fluid of claim 28, wherein the first monofunctional monomer comprises a monomer selected from the group consisting of N,N-dimethylacrylamide, sodium 2-acrylamido-2-methylpropanesulfonate, 2-acrylamido-2-methylpropanesulfonic acid, N-(hydroxymethyl)acrylamide, N-(hydroxyethyl)acrylamide, acrylamide, methacrylamide, N-vinylformamide, 1-vinyl-2-pyrrolidinone, N-vinylcaprolactam, N-acryloyl morpholine, N-methyl-N-vinylacetamide, N-isopropylacrylamide, N,N-diethylacrylamide, sodium 4-styrenesulfonate, and vinylsulfonic acid.

30. The cementing fluid of claim 28, wherein the primary crosslinker is present in the reaction at about 0.1% to about 20% by weight of total monomer.

31. The cementing fluid of claim 28, wherein the primary crosslinker comprises a crosslinking agent selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, and ethoxylated trimethylolpropane triacrylate, and any combination thereof.

32. The cementing fluid of claim 28, wherein the secondary crosslinker is present in the reaction at about 0.005% to about 0.5% by weight of total monomer.

33. The cementing fluid of claim 28, wherein the secondary crosslinker comprises a crosslinking agent selected from the group consisting of N,N′-methylenebisacrylamide, N,N′-(1,2-dihydroxy-1,2-ethanediyl)bisacrylamide, N,N′-(1,2-ethanediyl)bisacrylamide, and N,N′-[[2,2-bis(hydroxymethyl)-1,3-propanediyl]bis(oxymethylene)]bisacrylamide, bis(2-methacryloyl)oxyethyl disulfide, and N,N′-bis(acryloyl)cystamine, and any combination thereof.

34. The cementing fluid of claim 28 further comprising at least one selected from the group consisting of a weighting agent, a fine aggregate particulate, and any combination thereof.

35. The cementing fluid of claim 28, wherein the weight ratio of the first monofunctional monomer to the second monofunctional monomer in the reaction ranges from about 0.1:99.9 to about 99.9:0.1.

36. A method of producing a cement suspending agent, the method comprising:
providing an oil solution comprising an oil-based solvent and a surfactant;
providing a monomer mixture comprising an aqueous liquid, a first monofunctional monomer, and a primary crosslinker;
forming an inverse suspension with the monomer mixture and the oil solution;
reacting the monomer mixture in the inverse suspension with a free-radical initiator to form a crosslinked particulate; and
isolating the crosslinked particulate.

37. The method of claim 36, wherein the first monofunctional monomer comprises a monomer selected from the group consisting of N,N-dimethylacrylamide, sodium 2-acrylamido-2-methylpropanesulfonate, 2-acrylamido-2-methylpropanesulfonic acid, N-(hydroxymethyl)acrylamide, N-(hydroxyethyl)acrylamide, acrylamide, methacrylamide, N-vinylformamide, 1-vinyl-2-pyrrolidinone, N-vinylcaprolactam, N-acryloyl morpholine, N-methyl-N-vinylacetamide, N-isopropylacrylamide, N,N-diethylacrylamide, sodium 4-styrenesulfonate, and vinylsulfonic acid.

38. The method of claim 36, wherein the primary crosslinker is present in the reaction at about 0.1% to about 20% by weight of total monomer.

39. The method of claim 36, wherein the primary crosslinker comprises a crosslinking agent selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, and ethoxylated trimethylolpropane triacrylate, and any combination thereof.
